(19) United States
(12) Patent Application Publication
(10) Pub. No.: US 2025/0030063 A1
(43) Pub. Date: Jan. 23, 2025

(54) CELL WITH IMPROVED ABUSE TOLERANCE

(71) Applicant: Our Next Energy, Inc., Novi, MI (US)

(72) Inventors: Qingcheng Zeng, San Jose, CA (US); Tushar Swamy, San Jose, CA (US)

(73) Assignee: Our Next Energy, Inc., Novi, MI (US)

(21) Appl. No.: 18/779,575

(22) Filed: Jul. 22, 2024

Related U.S. Application Data
(60) Provisional application No. 63/528,327, filed on Jul. 21, 2023.

(51) Int. Cl. H01M 10/42; H01M 4/02; H01M 4/139; H01M 4/66; H01M 4/70; H01M 10/0525; H01M 10/0585; H01M 50/105; H01M 50/46

(52) U.S. Cl. CPC H01M 10/4235; H01M 4/139; H01M 4/661; H01M 4/667; H01M 4/70; H01M 10/0525; H01M 10/0585; H01M 50/105; H01M 50/46; H01M 2004/027; H01M 2004/028

(57) ABSTRACT

An anode-free cell including a cathode, an anode current collector and a separator disposed between the cathode and the anode current collector. It also includes a short-circuit limitation configuration configured by (i) the anode current collector and/or the cathode current collector being a polymer current collector, and/or (ii) the cathode dimension being the same as the anode current collector and/or of the separator dimension, or the dimension of the cathode being larger than the dimension of the anode current collector. The dimension is measured in the X-axis and/or Y-axis. Another cell includes a cathode and an anode and the short-circuit limitation configuration is configured by (i) the anode current collector being a polymer anode current collector and the cathode current collector being a polymer cathode current collector; and (ii) the dimension of the anode active material layer and of the cathode active material layer being the same.

### BACKGROUND

### Technical Field

The present disclosure generally relates to battery cells and more particularly to a structuring of anode-free cells and other cells to improve safety and abuse tolerance.

### Description of the Related Art

Battery cells have been used in many applications including electric vehicles and energy storage systems to provide a source of energy. The battery cells charge and discharge by moving metal ions between a positive electrode and a negative electrode. As a typical lithium-ion secondary battery, an active material capable of holding lithium is introduced into the positive electrode and the negative electrode, and charging/discharging is performed by exchanging lithium ions between the positive electrode active material and the negative electrode active material.

### BRIEF SUMMARY

According to an embodiment of the present disclosure, an anode-free cell is disclosed. The anode-free cell includes a cathode which includes a cathode current collector disposed between two cathode active material layers. The anode-free cell also includes an anode current collector and a separator disposed between the cathode and the anode current collector. The anode-free cell also includes a short-circuit limitation configuration configured by (i) the anode current collector and/or the cathode current collector being a polymer current collector, and/or (ii) a dimension of the cathode being the same as the dimension of the anode current collector and/or of the separator, or the dimension of the cathode being larger than the dimension of the anode current collector. The dimension is measured in the X-axis and/or Y-axis. Since deposition of lithium on the anode current collector is desired, lithium plating may not be an issue and thus some dimensional restrictions that may pose safety issues may not have to be followed.

In one embodiment, an anode-free cell includes a polymer current collector which further includes at least a metalized layer which is patterns with a full clearance pattern or dot connection pattern.

According to an embodiment of the present invention, a cell such as a lithium-ion cell is disclosed. The cell includes an anode which further includes an anode current collector disposed between two anode active material layers. The cell also includes a cathode that comprises a cathode current collector disposed between two cathode active material layers. The cell also includes a separator disposed between the cathode and the anode. A short-circuit limitation configuration of the cell is generated in which (i) the anode current collector is a polymer anode current collector and the cathode current collector is a polymer cathode current collector, and (ii) a dimension of the anode active material layer and of the cathode active material layer in the X and/or Y-axes are the same.

### BRIEF DESCRIPTION OF THE DRAWINGS

To easily identify the discussion of any particular element or act, the most significant digit or digits in a reference number refer to the figure number in which that element is first introduced.

FIG. 1A depicts a cross-section of at least a portion of an anode-free cell in accordance with an illustrative embodiment.

FIG. 1B depicts a cross-section of at least a portion of an anode-free cell after a charging operation in accordance with an illustrative embodiment.

FIG. 1C depicts a top view of a pouch and electrode tabs in accordance with an illustrative embodiment

FIG. 2 depicts a cross-section of at least a portion of an anode-free cell in a first configuration in accordance with an illustrative embodiment.

FIG. 3 depicts a cross-section of at least a portion of an anode-free cell in a second configuration in accordance with an illustrative embodiment.

FIG. 4 depicts a cross-section of at least a portion of an anode-free cell in a third configuration in accordance with an illustrative embodiment.

FIG. 5 depicts a cross-section of at least a portion of an anode-free cell in a fourth configuration in accordance with an illustrative embodiment.

FIG. 6 depicts a cross-section of at least a portion of an anode-free cell in a fifth configuration in accordance with an illustrative embodiment.

FIG. 7 depicts a top view of at least a portion of an anode-free cell illustrating full clearance lines in accordance with an illustrative embodiment.

FIG. 8 depicts a cross-section of at least a portion of the anode-free cell of FIG. 7 in accordance with an illustrative embodiment.

FIG. 9 depicts a top view of at least a portion of an anode-free cell illustrating dot connection lines in accordance with an illustrative embodiment.

FIG. 10 depicts a cross-section of at least a portion of the anode-free cell of FIG. 9 in accordance with an illustrative embodiment.

FIG. 11 depicts a cross-section of at least a portion of a lithium ion cell in accordance with an illustrative embodiment.

FIG. 12 depicts a routine in accordance with an illustrative embodiment.

FIG. 13 depicts a routine in accordance with an illustrative embodiment.

FIG. 14 depicts a functional block diagram of a computer hardware platform in accordance with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together—intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein.

Turning now to an overview of technologies that generally relate to the present teachings, anode-free, anode-less or initial anode-free cells, are a type of lithium metal cells. Lithium-metal cells may work in a similar fashion to lithium-ion cells but instead of using a graphite anode host material, may use a high-energy lithium metal. Anode-free lithium (Li) metal cells are lithium metal cells that may be manufactured without a lithium metal anode, or any other anode host material, such as graphite, titanate, iron-oxide, silicon, silicon-oxide. In some embodiments discussed herein, the anode-free cells may be cells wherein a lithium anode is subsequently generated, after manufacturing, inside the cell during operation as the cell changes under an external influence when the cell is charged the first time. However, in other embodiments discussed herein, anode-free cells may be cells in which all lithium may be removed from the cathode when the cell is fully charged. Lithium ions, provided by the cathode active material, are deposited as metallic lithium onto a metal substrate, such as copper or nickel foil or mesh to create the working cell. Though anode-free, anode-less or initial anode-free cells are discussed herein, these are not meant to be limiting as the methods and systems may also equally apply to lithium metal cells in general. Lithium metal and anode-free lithium cells may have certain advantages over traditional lithium ion, as they are more energy dense. Anode-free cells may also be less expensive and easier to assemble due to their lack of anode coating and ability to utilize Li-metal's full capacity. The illustrative embodiments are further directed to other cells including both an anode an a cathode wherein the Anode/positive A/P ratio <=1 as described hereinafter.

The illustrative embodiments recognize that it is typically difficult for anode-free cells to pass abuse tests due to the structure of the anode current collector. Further, conventional cell design may typically follow dimensional restrictions wherein the size of the separator of the cell is larger than the size of the anode or anode current collector of the cell which is in turn larger than the size of the cathode. This may be performed to prevent or alleviate lithium plating as, for example, sizing the anode to be larger than the cathode may provide enough volume for intercalating lithium ions from the cathode to be received and thus alleviate lithium plating.

The illustrative embodiments recognize that certain traditional dimensional restrictions may reduce cell energy density, introduce safety and short-circuiting concerns and make manufacturing more difficult.

The illustrative embodiments disclose an anode-free cell that includes a cathode which includes a cathode current collector disposed between two cathode active material layers. The anode-free cell also includes an anode current collector and a separator disposed between the cathode and the anode current collector. The anode-free cell also includes a short-circuit limitation configuration configured by (i) the anode current collector and/or the cathode current collector being a polymer current collector, and/or (ii) a dimension of the cathode being the same as the dimension of the anode current collector and/or of the separator (for example, within 1 mm of each other, such as within 0.5 mm or within 0.1 mm, or within 0.01 mm or within 0 mm of each other), or the dimension of the cathode being larger (for example, greater than 0.1 mm, such as greater than 1 mm) than the dimension of the anode current collector, the dimension being measured in the X-axis and/or Y-axis as discussed herein. Since deposition of lithium on the anode current collector is desired, lithium plating may not be an issue and thus some dimensional restrictions that may pose safety issues may not have to be followed.

The illustrative embodiments further disclose a cell, such as a lithium-ion cell that comprises an anode including an anode current collector disposed between two anode active material layers. The cell also includes a cathode that comprises a cathode current collector disposed between two cathode active material layers. The cell also includes a separator disposed between the cathode and the anode. A short-circuit limitation configuration of the cell is generated wherein (i) the anode current collector is a polymer anode current collector and the cathode current collector is a polymer cathode current collector, and (ii) a dimension of the anode active material layer and of the cathode active material layer in the X and/or Y-axes are the same (for example, within 0.5 mm of each other, such as within 0.3 mm or within 0.1 mm or within 0.01 mm or within 0 mm of each other).

### Example Architecture

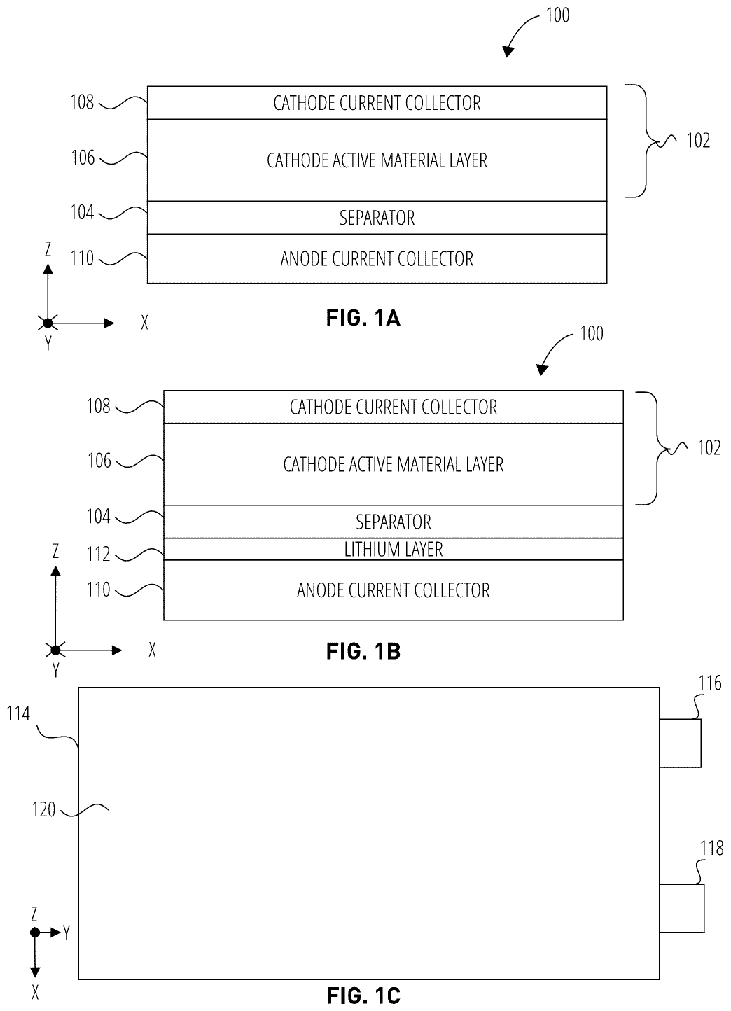

Turning to FIG. 1A and FIG. 1B, a general structure of at least a portion of the anode-free cell 100 is shown. The anode-free cell 100 comprises a cathode 102, a separator 104, a cathode current collector 108, and an anode current collector 110. The cathode current collector 108 may comprise at least a conductive film that further comprises, for example, an aluminum foil. Other materials of conductive foils are possible. The cathode active material layer 106 of FIG. 1A and FIG. 1B may comprise a first surface in contact with the cathode current collector 108, and an opposite surface that may be in contact with the separator 104. The separator may prevent a direct electrical connection between the cathode 102 and the anode current collector 110. In this configuration, prior to a first charging cycle, the anode-free cell 100 does not have an anode or lithium layer 112. The separator 104 may have characteristics that further inhibit dendrite growth.

The separator 104 may have a first surface in contact with the cathode 102 and a second surface opposite the first surface in contact the anode current collector 110. In some embodiments, the anode current collector 110 comprises at a conductive foil, such as a copper foil. As shown in FIG. 1B, lithium ions, provided by the active cathode material, may be deposited as metallic lithium (lithium layer 112) onto the anode current collector 110. An electrolyte of the anode-free cell may comprise lithium difluoro (oxalato) borate, lithium tetrafluoroborate and a solvent component. However, other electrolytes may be used. Further, the cathode may be, for example, Lithium Nickel Manganese Cobalt Oxides (NMC)-Li(NixMnyCoz)O2 where 0≤x,y,z≤1, Lithium Manganese Oxide (LMO)-LiMn2O4, Lithium Manganese Iron Phosphate (LMFP)-LiMnxFeyPO4 where 0<x,y<1, Lithium Iron Phosphate (LFP)-LiFePO4, or Lithium Cobalt Oxide (LCO)-LiCoO2.

FIG. 1C illustrates a top view of a pouch 114 or housing of a cell described herein. The pouch 114 may comprise a large wall surface 120 that is parallel to the YX plane, the YX plane being a two-dimensional plane in three-dimensional space that is perpendicular to the Z-axis and more specifically a two-dimensional plane in three-dimensional space that is perpendicular to a surface of the cell through which the positive tab 118 and/or negative tab 116 of the cell passes from inside the pouch 114 to be exposed outside the pouch 114. The pouch 114 may house, for example, a stack of multiple electrode layers.

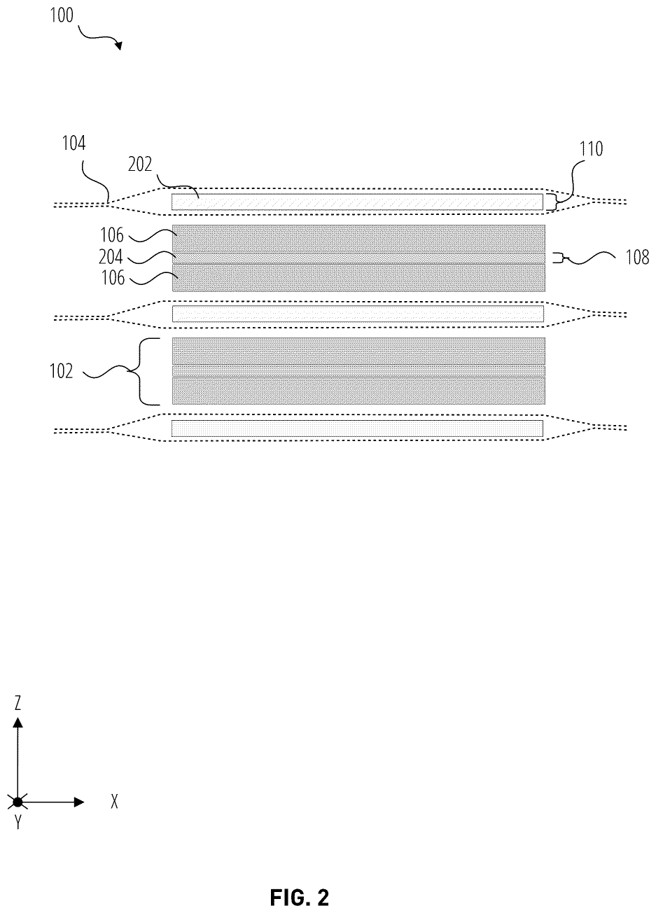

FIG. 2 illustrates a cross-section of at least a portion of an anode-free cell 100 in a first configuration in accordance with an illustrative embodiment. The anode-free cell 100 comprises a pouch 114 (not shown in FIG. 2) extending along a first axis (X-axis) to define a width, a second axis (Y-axis) orthogonal to the first axis to define a length, and a third axis (Z-axis) orthogonal to the first and second axes to define a thickness. The cross-section may be in the ZX plane which may be a two-dimensional plane in three-dimensional space that is perpendicular to the Y-axis and more specifically a two-dimensional plane in three-dimensional space that is perpendicular to the large wall surface 120. The anode-free cell 100 comprises a cathode 102 that comprises a cathode current collector 108 disposed between two cathode anode active material layers 1104. The anode-free cell 100 further comprises an anode current collector 110 and a separator 104 disposed between the cathode 102 and the anode current collector 110.

The anode-free cell further comprises a short-circuit limitation configuration or abuse effect limitation configuration that may be configured by (i) the anode current collector and/or the cathode current collector being built as a polymer current collector; and/or (ii) a dimension of the cathode being the same as the dimension of the anode current collector and/or of the separator, or the dimension of the cathode being larger than the dimension of the anode current collector. The dimension may be the width in the X-axis and/or length in the Y-axis. Thus, the cathode width and/or length dimensions do not have to be the smallest compared to similar dimensions of the anode current collector and separator. This may in some embodiments enable ease of manufacturing, especially when the dimensions are the same, as components of the cell may be manufactured and assembled by laminating and cutting with relatively simple mechanical positioning systems as opposed to complex sensor-based positioning systems the use precise determinations of physical locations and dimensions of cell components being assembled together when the sizes a dissimilar. The dimensioning may further increase cell energy density due to a removal of a limiting cathode size.

In the specific configuration of FIG. 2, the anode current collector dimensions in the X and/or Y axis may be the same as the corresponding cathode dimensions. However, the anode current collector dimensions may be smaller than that of the cathode.

Two separators on both sides of the anode current collector 110 may be structured to enclose or converge around at least a portion of the anode current collector 110. This may also help alleviate potential short circuiting in abuse situations such as external pressure being applied to the cell. The separator may enclose the anode current collector enough at least beyond a width of the cathode active material layer 106 so that in abuse situations, the anode current collector 110 is protected from contact with the cathode active material layer 106.

In the case of the dimension of the cathode being larger than the dimension of the anode current collector may be at least partially enclosed by the separators and the cathode ceramic or oxide material which may have low conductivity may be exposed. So, in case of sideways impact or squeeze abuse, it is the cathode may be impacted rather than the anode current collector, thus reducing potential short circuit between the cathode and the anode current collector.

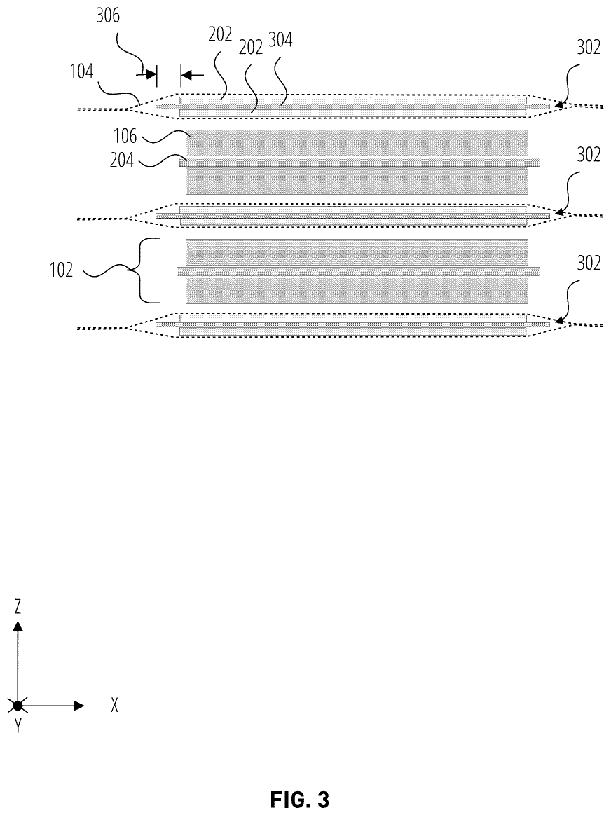

FIG. 3 illustrates a cross-section of at least a portion of an anode-free cell 100 in the XZ plane in a second configuration in accordance with an illustrative embodiment. The second configuration depicts the use of a polymer current collector (PCC) wherein the anode current collector is designed as a polymer anode current collector 302. A polymer current collector used herein may generally comprise a polymer layer disposed between two metal layers. In the configuration of FIG. 3, the polymer anode current collector 302 comprises a first polymer layer 304 disposed between two first metal layers 202. The first polymer layer 304 may comprise polypropylene (PP), and a first metal layer 202 may comprise copper.

In the specific configuration of FIG. 3, the first metal layers 202 may be dimensioned to be the same as the dimensions of the cathode in the X and/or Y axis and the first polymer layer 304 may be larger. This may generate a non-metalized extension 306 of the polymer anode current collector 302 as shown in FIG. 3. In one or more examples, the non-metalized extension 306 may be from 2-5 mm in in the X-axis and/or Y-axis. The non-metalized extension 306 may be non-conductive.

The use of a polymer current collector may limit current flow to improve abuse tolerance, may further reduce current collector weight and thickness, and may increase energy density. The increase in energy density may be due to the PCC generally being thinner and reducing an overall weight of current collector. The density of the polymer layer may be lower relative to that of the metal. Thus, a PCC having a total thickness as that of a metal used alone as a current collector, has a relatively lower weight. In an embodiment, the thicknesses of a PCC used as the polymer anode current collector 302 include about 1μ thick Cu (“about” being, for example +/−1% to +/−10%) on both sides of an about 4μ thick polymer layer. In another embodiment, the thickness of a PCC used on the cathode side is about 1μ thick Al on both sides of an about 6μ or about thick PET, (“about” being, for example +/−1% to +/−10%). In another example, the total PCC (anode current collector) thickness is about 6μ and the total PCC (cathode current collector) thickness is about 6μ or about 12μ. In the configuration of FIG. 3, the cathode current collector 108 may comprise a second metal layer 204. Of course, this is not meant to be limiting as variations may be obtained in view of the descriptions and figures.

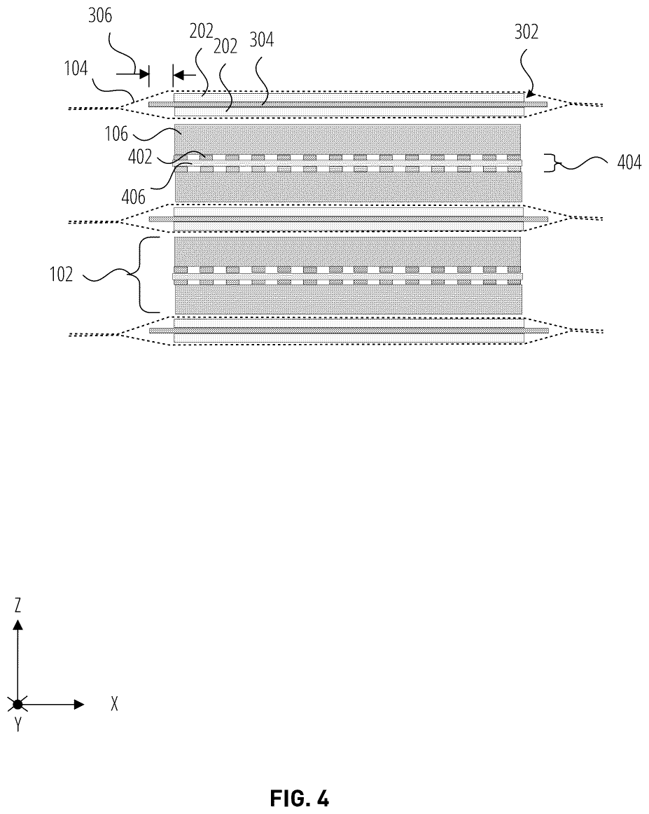

FIG. 4 illustrates a cross-section of at least a portion of an anode-free cell in a third configuration in which the cathode current collector is a polymer cathode current collector 404 and the polymer cathode current collector 404 is patterned. In some embodiments, the anode current collector may also or instead be patterned. In the specific configuration of FIG. 4, the anode current collector and cathode dimensions may be the same in the X and/or Y axes. The polymer cathode current collector 404 may comprise a second polymer layer 406 disposed between two second metal layers 204. The second metal layers may be patterned as patterned second metal layers 402. Patterning may not be mandatory in all embodiments. However, patterning may help reduce short circuit currents as discussed herein. Further, as discussed herein, the second polymer layer may comprise polyethylene terephthalate (PET), and the second metal layer may comprise aluminum.

In as aspect herein, the cell may comprise a polymer anode current collector 302 and the dimension of the polymer layer in the X and/or Y axes may be greater than the dimension of the two first metal layers 202 in the same axes. This may generate the non-metalized extension 306 of the polymer anode current collector 302 as shown in FIG. 4. In one or more examples, the non-metalized extension 306 may be from 2-5 mm in in the X-axis and/or Y-axis.

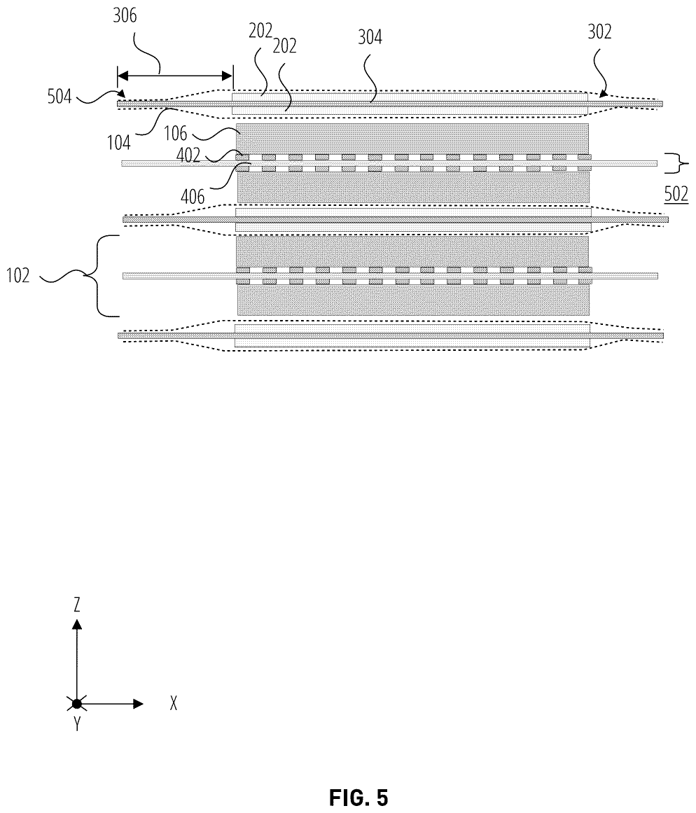

In some embodiments as shown in FIG. 5, the non-metalized extension 306 may be further extended into the end portion 504 of the separator 104 so that the separator can be cut with the first polymer layer 304 at the same time. In that case the cutting may not include cutting the active material. FIG. 5 illustrates a cross-section of at least a portion of an anode-free cell in a fourth configuration in which the dimensions in the X and/or Y axes of the first polymer layer 304 and of the second polymer layer 406 are the same and the dimensions in the X and/or Y axes of the first metal layer 202 and of the second metal layer (patterned second metal layer 402 in FIG. 5) are the same.

When the non-metalized extension 306 is extended into the end portion 504, short circuits may be alleviated or prevented from forming if the separator shrinks in an abuse situation due to the non-metalized extension 306 serving as a fail-safe to prevent contact between the cathode active material layer 106 and the first metal layer 202.

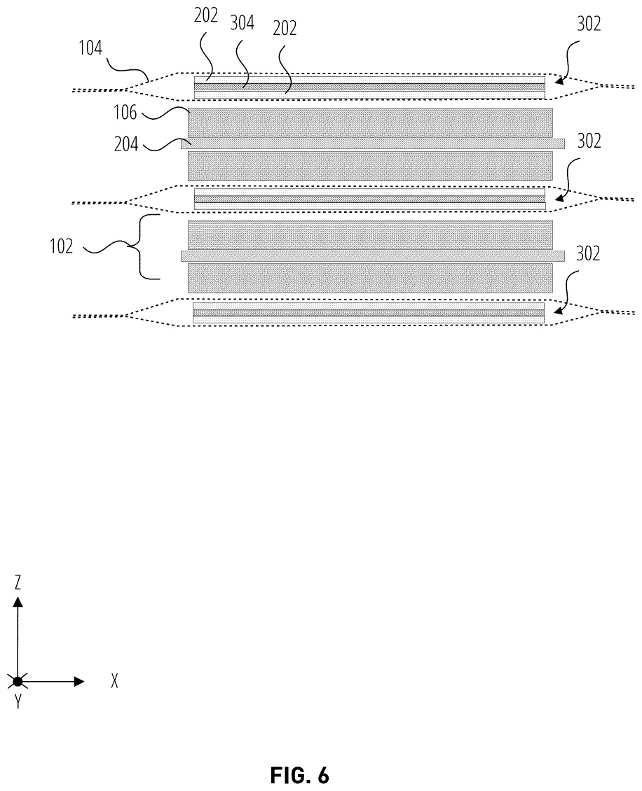

FIG. 6 illustrates a cross-section of at least a portion of an anode-free cell in a fifth configuration in which the dimensions of the anode current collector (polymer anode current collector 302 in this case) is smaller than the dimensions of the cathode 102 in the X and/or Y axes. Lithium deposition on the anode current collector may be desired in the anode-free cell. Dimensional restrictions on the cathode size (to be smaller than the anode current collector size) to prevent lithium plating may be unnecessary.

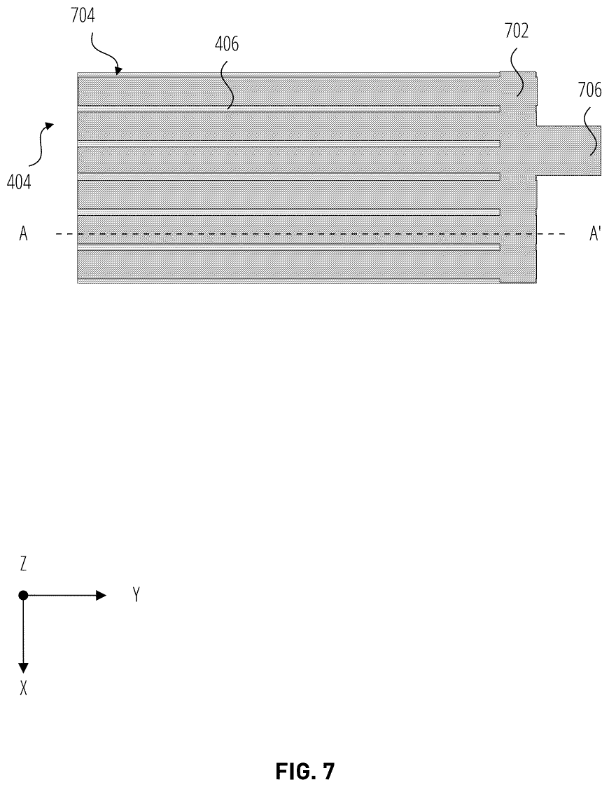

FIG. 7 illustrates a top view of at least a portion of an anode-free cell depicting full clearance lines 704 and tab 706 in a polymer cathode current collector 404 that is patterned. The full clearance line 704 may be a plurality of empty areas generated on a second metal layer to form the patterned second metal layer 402. The patterned second metal layer 402 is shown in FIG. 7 as a patterned second metal layer with full clearance 702. Between two patterned second metal layers with full clearances 702 may be disposed a second polymer layer 406 which may be non-patterned.

The width in the X-axis of at least one of the full clearance lines 704 may be, for example, from 10-30 μm The distance between adjacent full clearance lines in the X-axis direction may be from 1-5 mm.

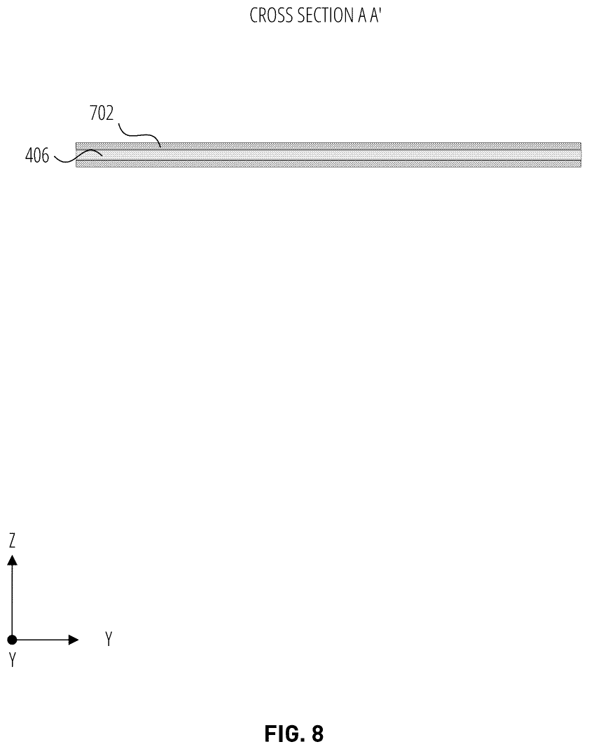

FIG. 8 illustrates a cross-section of the polymer current collector of FIG. 7 taken in the AA′ plane.

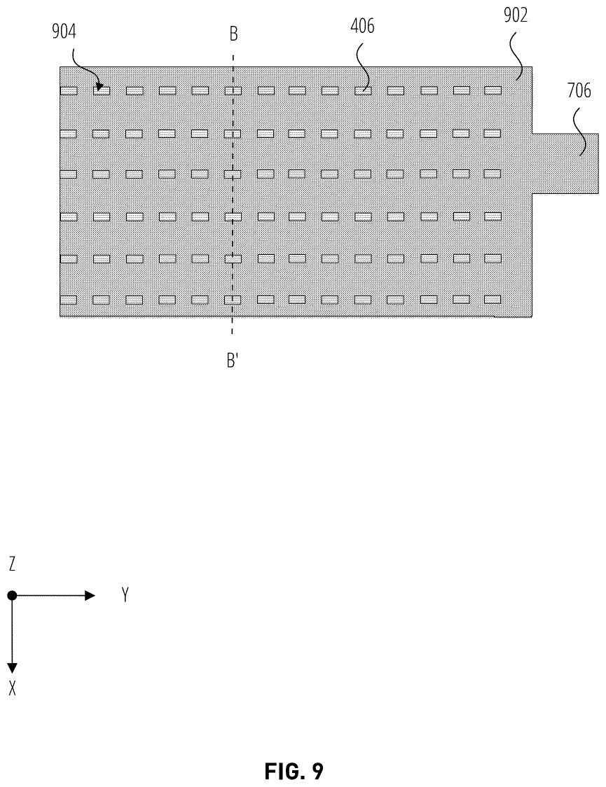

FIG. 9 illustrates a top view of at least a portion of an anode-free cell illustrating dot connection lines 904 and tab 706 in a polymer cathode current collector 404 that is patterned. The dot connection lines 904 may be a plurality of empty areas generated on a second metal layer to form the patterned second metal layer 402. The patterned second metal layer 402 is shown in FIG. 9 as a patterned second metal layer with dot connection 902. Between two patterned second metal layers with dot connections 902 may be disposed a second polymer layer 406 which may be non-patterned.

A length in the Y axis direction of at least one of the dot connection lines may be, for example, from 0.01-0.5 mm. Other dimensions may include a spacing of 0.05-10 mm between dot connection lines in the Y axis direction.

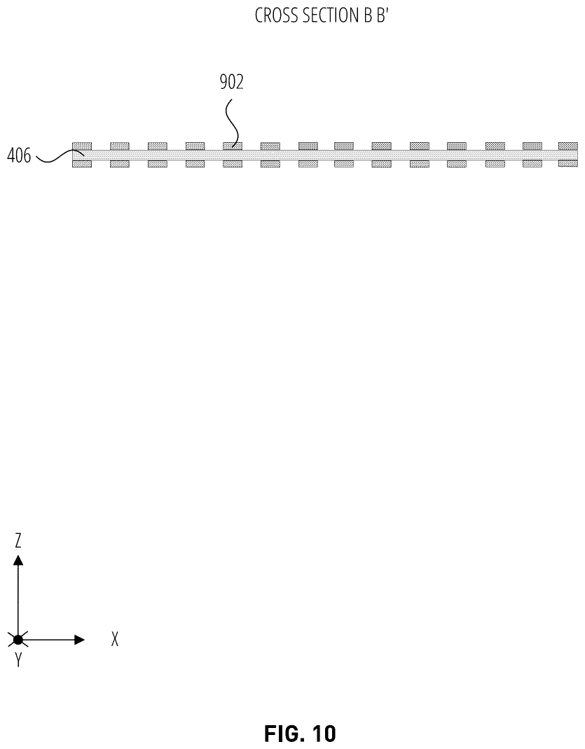

FIG. 10 illustrates a cross-section of the polymer current collector of FIG. 9 taken in the BB′ plane.

Patterning, as shown in FIG. 7-FIG. 10 may provide one axis direction with high power and one direction with low power. Specifically, in FIG. 7, the patterning may reduce the conductivity in the X direction due to the empty spaces created by the full clearance lines 704. The patterning may however provide or keep a relatively large conductivity in the Y direction as currents may be forced to move in that direction. This is helpful for short circuit situations. In a short circuit, the current may flow in the Y direction to get to the next adjacent strip of conductive metal layer. In the full clearance, the current flow in the X direction may at least be attenuated. Thus, the resistance in the X direction may be significantly increased. This reduces the power in that direction. By the equation E=I²Rt, as R is increased and I is decreased, E is also decreased by I is squared. Thus, a short circuit may have minimum impact because as it may be degraded to a “soft” short circuit rather than a “hard” short circuit relative to a polymer cathode current collector 404 without patterning. This may also occur in the configuration of FIG. 9, albeit to a lesser extent.

Patterning may be performed by creating empty spaces between portions of the metal foil. This may be achieved, for example, during plating in a physical vapor deposition (PVD) method by masking areas that should not be plated with the metal. Laser or chemical etching can also be used to create the pattern.

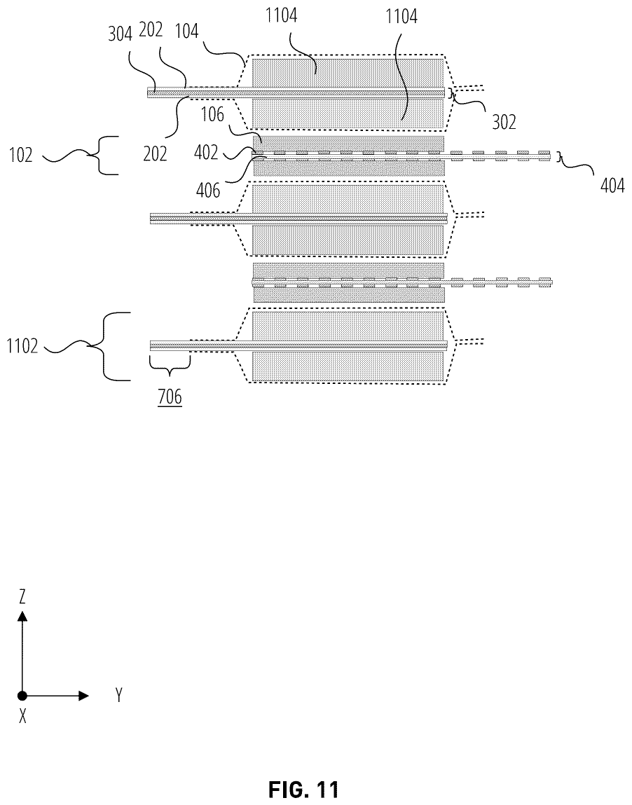

FIG. 11 depicts a cross-section of at least a portion of a cell such as lithium-ion cell wherein both the anode current collector and the cathode current collector are polymer current collectors and the cell includes an anode. More specifically, the cell comprises an anode 1102 including an anode current collector disposed between two anode active material layers 1104. The cell further comprises a cathode 102 including a cathode current collector disposed between two cathode active material layers 106, and a separator disposed between the cathode 102 and the anode 1102;

The cell further comprises a short-circuit limitation configuration in which (i) the anode current collector is a polymer anode current collector 302 and the cathode current collector is a polymer cathode current collector 404; and (ii) a dimension of the anode active material layer 1104 and of the cathode active material layer 106 in the X and/or Y-axes are the same. The cross-section of FIG. 11 is parallel to the YZ plane and thus a tab 706 of the polymer anode current collector 302 can be seen.

In as aspect, the electrolyte used may be an electrolyte with dendrite prevention or suppressing function (for example, a solid electrolyte, a semi solid electrolyte, a gel electrolyte or a liquid electrolyte). The electrolyte may be configured to prevent or alleviate lithium plating and dendrite formation along with the configuration of the separator. A configuration may include, for example, LiBF4+LIDFO+FEC+DEC base electrolyte. Thus, an anode/positive electrode ratio (A/P ratio) may be less than or equal to 1 due to lithium plating no longer being an issue. The A/P ratio may represent a ratio of the mass of the active material in the anode to the mass of the active material in the cathode, or the anode to cathode ration of area energy. Further the current collectors may be structured as Al/PET/Al or Cu/PP/Cu.

In another aspect, the dimension of the polymer anode current collector 302 and/or of the polymer cathode current collector 404 in the X and/or Y-axes may be larger than the dimension of the cathode active material layer 106 and of the anode active material layer 1104 in the X and/or Y-axes.

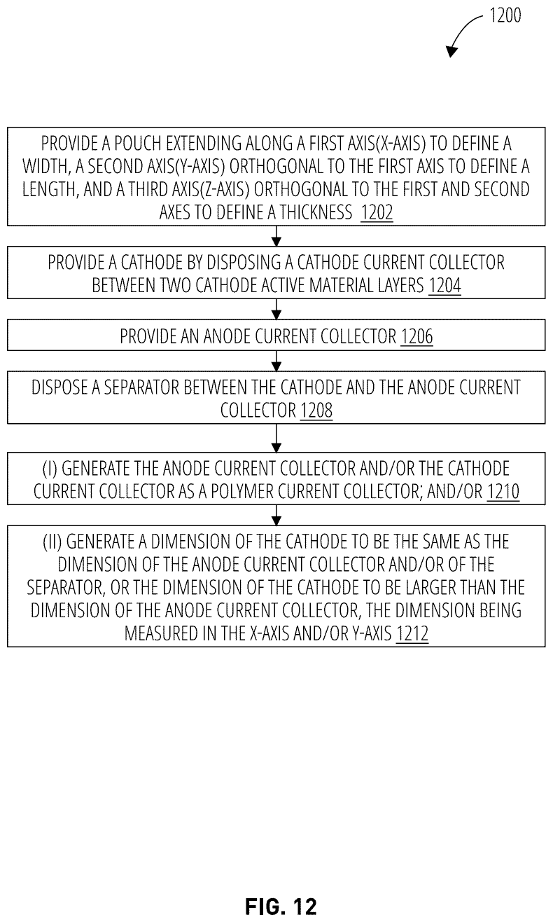

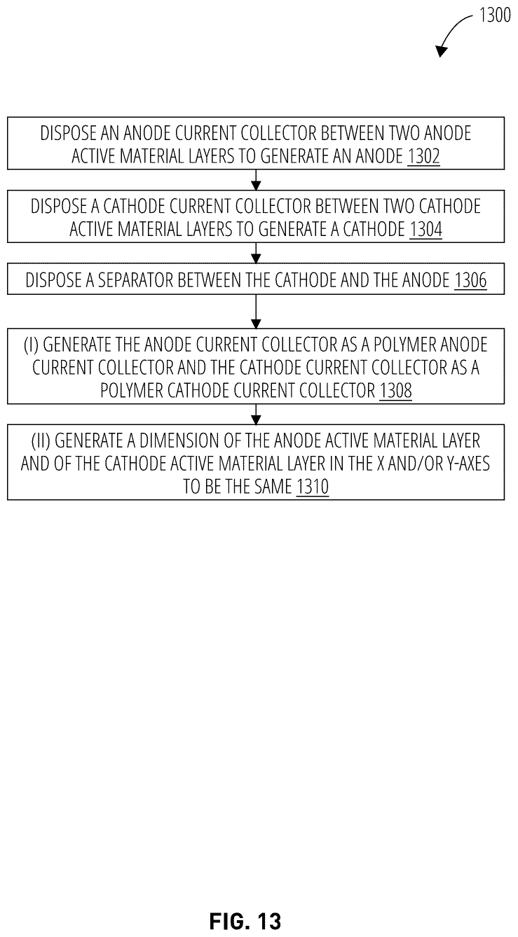

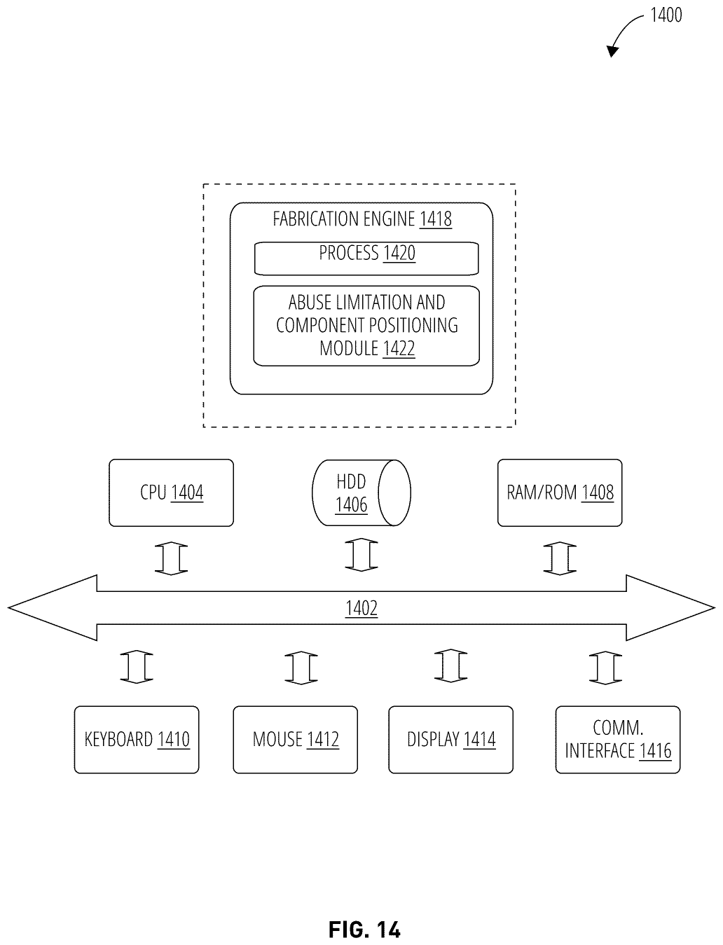

FIG. 12 illustrates a routine 1200 for manufacturing an anode-free cell according to an illustrative embodiment. The routine 1200 may be performed by fabrication engine 1418 of FIG. 14. In block 1202, fabrication engine 1418 provides a pouch extending along a first axis (X-axis) to define a width, a second axis (Y-axis) orthogonal to the first axis to define a length, and a third axis (Z-axis) orthogonal to the first and second axes to define a thickness. In block 1204, fabrication engine 1418 provides a cathode by disposing a cathode current collector between two cathode active material layers. In block 1206, fabrication engine 1418 provides an anode current collector. In block 1208, fabrication engine 1418 disposes a separator between the cathode and the anode current collector. Fabrication engine 1418 configures a short-circuit limitation configuration by (i) generating in block 1210 the anode current collector and/or the cathode current collector as a polymer current collector; and/or (ii) generating in block 1212 a dimension of the cathode to be the same as the dimension of the anode current collector and/or of the separator, or the dimension of the cathode to be larger than the dimension of the anode current collector, the dimension being measured in the X-axis and/or Y-axis.

FIG. 12 illustrates a routine 1300 for manufacturing a cell such as a lithium-ion cell according to an illustrative embodiment. The routine 1300 may be performed by fabrication engine 1418 of FIG. 14 In block 1302, fabrication engine 1418 disposes an anode current collector between two anode active material layers to generate an anode. In block 1304, fabrication engine 1418 disposes a cathode current collector between two cathode active material layers to generate a cathode. In block 1306, fabrication engine 1418 disposes a separator between the cathode and the anode. Fabrication engine 1418 configures a short-circuit limitation configuration by (i) generating in block 1308 the anode current collector as a polymer anode current collector and the cathode current collector as a polymer cathode current collector and (ii) generating in block 1310 a dimension of the anode active material layer and of the cathode active material layer in the X and/or Y-axes to be the same.

### Example Computer Platform

As discussed above, functions relating to methods and systems for fabricating a cell with increase abuse tolerance can use of one or more computing devices connected for data communication via wireless or wired communication. FIG. 14 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1400 may include a central processing unit (CPU) 1404, a hard disk drive (HDD) 1406, random access memory (RAM) and/or read only memory (ROM) 1408, a keyboard 1410, a mouse 1412, a display 1414, and a communication interface 1416, which are connected to a system bus 1402.

In one embodiment, the hard disk drive (HDD) 1406, has capabilities that include storing a program that can execute various processes, such as the fabrication engine 1418, in a manner described herein. The fabrication engine 1418 may have various modules configured to perform different functions. For example, there may be a process module 1420 configured to control the different manufacturing processes discussed herein and others. There may be an abuse limitation and component positioning module 1422 operable to provide an appropriate dimensioning, mechanical positioning, lamination, and in general, assembly of a cell.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. An anode-free cell comprising:
a pouch extending along a first axis (X-axis) to define a width, a second axis (Y-axis) orthogonal to the first axis to define a length, and a third axis (Z-axis) orthogonal to the first and second axes to define a thickness;
a cathode comprising a cathode current collector disposed between two cathode active material layers;
an anode current collector;
a separator disposed between the cathode and the anode current collector;
further comprising a short-circuit limitation configuration configured by:
(i) the anode current collector and/or the cathode current collector being a polymer current collector; and/or
(ii) a dimension of the cathode being the same as the dimension of the anode current collector and/or of the separator, or the dimension of the cathode being larger than the dimension of the anode current collector, the dimension being measured in the X-axis and/or Y-axis.

2. The anode-free cell of claim 1, wherein the separator encloses at least a portion of the anode current collector.

3. The anode-free cell of claim 1, wherein:
the short-circuit limitation configuration includes the polymer current collector, and the polymer current collector comprises a polymer layer disposed between two metal layers.

4. The anode-free cell of claim 3, wherein:
the polymer current collector is a polymer anode current collector,
the polymer layer comprises polypropylene (PP), and/or
the two metal layers each comprise copper.

5. The anode-free cell of claim 3, wherein:
the polymer current collector is a polymer cathode current collector,
the polymer layer comprises polyethylene terephthalate (PET), and/or
the two metal layers each comprise aluminum.

6. The anode-free cell of claim 3, wherein the polymer current collector is a polymer anode current collector and the width and/or length of the polymer layer is greater than the width and/or length of the two metal layers, and
wherein the anode-free cell further comprises a non-metalized extension of the polymer anode current collector.

7. The anode-free cell of claim 6, wherein the non-metalized extension is from 2-5 mm in width and/or length in the X-axis and/or Y-axis, respectively.

8. The anode-free cell of claim 1, wherein:
the short-circuit limitation configuration includes the polymer current collector, and
the polymer current collector is patterned.

9. The anode-free cell of claim 8, wherein the polymer current collector comprises at least a metal layer which further includes a full clearance pattern comprising a plurality of full clearance lines.

10. The anode-free cell of claim 9, wherein a width of at least one of the full clearance lines in the X-axis direction is from 10-30 um.

11. The anode-free cell of claim 9, wherein a distance between adjacent full clearance lines in the X-axis direction is from 1-5 mm.

12. The anode-free cell of claim 8, wherein the polymer current collector comprises at least a metal layer which further includes a dot connection pattern comprising a plurality of dot connection lines.

13. The anode-free cell of claim 12, wherein a length of at least one of the dot connection lines in the Y-axis direction is from 0.01-0.5 mm.

14. A method of manufacturing an anode-free cell comprising:
providing a pouch extending along a first axis (X-axis) to define a width, a second axis (Y-axis) orthogonal to the first axis to define a length, and a third axis (Z-axis) orthogonal to the first and second axes to define a thickness;
providing a cathode by disposing a cathode current collector between two cathode active material layers;
providing an anode current collector;
disposing a separator between the cathode and the anode current collector; and
configuring a short-circuit limitation configuration by:
(i) generating the anode current collector and/or the cathode current collector as a polymer current collector; and/or
(ii) generating a dimension of the cathode to be the same as the dimension of the anode current collector and/or of the separator, or the dimension of the cathode to be larger than the dimension of the anode current collector, the dimension being measured in the X-axis and/or Y-axis.

15. A cell comprising:
an anode comprising an anode current collector disposed between two anode active material layers;
a cathode comprising a cathode current collector disposed between two cathode active material layers;
a separator disposed between the cathode and the anode;
further comprising a short-circuit limitation configuration wherein:
(i) the anode current collector is a polymer anode current collector and the cathode current collector is a polymer cathode current collector; and
(ii) a dimension of the anode active material layer and of the cathode active material layer in the X and/or Y-axes are the same.

16. The cell of claim 15, wherein an anode/positive electrode ratio (A/P ratio) is less than or equal to 1.

17. The cell of claim 15, wherein the separator encloses at least a portion of the anode current collector.

18. The cell of claim 15, wherein the dimension of the polymer anode current collector and/or of the polymer cathode current collector in the X and/or Y-axes is larger than the dimension of the cathode active material layer and of the anode active material layer in the X and/or Y-axes.

19. The cell of claim 15, wherein the cathode current collector comprises aluminum and the anode current collector comprises copper.

20. A method of manufacturing a cell comprising:
disposing an anode current collector between two anode active material layers to generate an anode;
disposing a cathode current collector between two cathode active material layers to generate a cathode;
disposing a separator between the cathode and the anode;
configuring a short-circuit limitation configuration by:
(i) generating the anode current collector as a polymer anode current collector and the cathode current collector as a polymer cathode current collector; and
(ii) generating a dimension of the anode active material layer and of the cathode active material layer in the X and/or Y-axes to be the same.
